(19) United States
(12) Patent Application Publication
(10) Pub. No.: US 2005/0039217 A1
(43) Pub. Date: Feb. 17, 2005

(54) Cable modem module unit and electronic unit

(75) Inventors: Shuji Abe, Kumagaya-shi (JP); Katsuya Kudo, Fukaya-shi (JP); Tsutomu Isoda, Takasaki-shi (JP); Masami Oosawa, Kumagaya-shi (JP); Mikine Fujihara, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/916,636

(22) Filed: Aug. 12, 2004

(30) Foreign Application Priority Data
Aug. 12, 2003 (JP) 2003-292348

(51) Int. Cl. H04N 7/173; H01R 13/514; H01R 13/502

(52) U.S. Cl. 725/111; 725/109; 725/110; 725/119; 725/120

(57) ABSTRACT

A cable modem module unit includes a tuner section configured with an analog signal processing unit for transmitting/receiving a high frequency signal via a coaxial connector, a first shield case configured to hold the tuner section therein with the coaxial connector externally exposed, a circuit board having the first shield case thereon and configured to provide a digital signal processing section including a memory for allowing the inputting and outputting of digital data, the digital signal processing section performing digital processing on a signal input to and output from the tuner section, and a second shield case configured to hold the circuit board and first shield case therein with the coaxial connector externally exposed, on the same plane of the circuit board, the coaxial connector and memory being located in an opposed relation with the first shield case in between.

### CROSS-REFERENCE TO RELATED APPLICATIONS

This application is based upon and claims the benefit of priority from prior Japanese Patent Application No. 2003-292348, filed Aug. 12, 2003, the entire contents of which are incorporated herein by reference.

### BACKGROUND OF THE INVENTION

1. Field of the Invention

The present invention relates to a cable modem module unit providing an interface to a network using, for example, a CATV (Cable Television) line. Further, the present invention also relates to an electronic unit with the above-mentioned cable modem module unit incorporated therein.

2. Description of the Related Art

As well known in the art, a cable modem unit has been developed as an interface for connecting an electronic unit, such as a user's PC (Personal Computer), to, for example, a network using a CATV line. This cable modem unit has been currently manufactured as an independent unit directly handled by the user, that is, as an individual product separate from the electronic unit.

Usually, the cable modem unit is equipped, on a back panel, with an RF (Radio Frequency) coaxial connector for connection to a CATV highway, an Ethernet connector or jack for connection to PC, etc., a reset switch for resetting a device to an initial state, a power supply connector for receiving a power supply, and so on.

Further, the cable modem unit has, at a front panel, an LED or LCD display section, for displaying a supply state of supply power, a state of connection to a central CATV station, a state of connection to a PC or other function states, as well as a power supply switch for turning the unit ON or OFF, and so on.

Currently, the cable modem unit is held in a housing made of a synthetic resin material and its shape is decided based on whether it is to installed near a PC or hung on a wall.

Incidentally, along with the current tendencies toward a higher integration and higher performance of associated circuit components, as well as improved mounting techniques, the cable modem unit is desired to be made much lower in cost, more compact, and lighter in weight. From the standpoint of its size, therefore, such a cable modem unit may be incorporate into a specific electronic unit.

However, the cable modem unit must be modified to be incorporated into a specific electronic unit. This is inevitably because the cable modem unit is designed as a unit independent of any other electronic units.

JPN PAT APPLN KOKAI PUBLICATION NO.2002-16524 discloses a transmit/receive-integral type high frequency unit with a receive-system block and transmit-system block incorporated into one housing. However, there is no description in the KOKAI PUBLICATION about incorporating, into a predetermined electronic unit, a housing where the receive-system and transmit-system blocks are provided.

### BRIEF SUMMARY OF THE INVENTION

According to one aspect of the present invention, there is provided a cable modem module unit comprising: a tuner section configured with an analog signal processing unit for transmitting/receiving a high frequency signal via a coaxial connector; a first shield case configured to hold the tuner section therein with the coaxial connector externally exposed; a circuit board having the first shield case thereon and configured to provide a digital signal processing section including a memory for allowing the inputting and outputting of digital data, the digital signal processing section performing digital processing on a signal input to and output from the tuner section; and a second shield case configured to hold the circuit board and first shield case therein with the coaxial connector externally exposed, on the same plane of the circuit board, the coaxial connector and memory being located in an opposed relation with the first shield case in between.

According to another aspect of the present invention, there is provided an electronic unit comprising: a cable modem module unit comprising a tuner section configured with an analog signal processing section for transmitting/receiving a high frequency signal via a coaxial connector, a first shield case configured to hold the tuner section therein with the coaxial connector externally exposed, a circuit board having the first shield case thereon and configured to provide a digital signal processing section including a memory for allowing the inputting and outputting of digital data, the digital signal processing section performing digital processing on a signal input to and output from the tuner section, and a second shield case configured to hold the circuit board and first shield case therein with the coaxial connector externally exposed, on the same plane of the circuit board, the coaxial connector and memory being located in an opposed relation with the first shield case in between; and a power supply section configured to supply power to the cable modem module unit, the cable modem module unit is operated with the use of the power supplied from the power supply section.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 shows one embodiment of the present invention and a schematic view for explaining an outline of a CATV broadcasting system;

FIG. 2 is a perspective view for explaining a structure of a CATV terminal unit in the CATV broadcasting system;

FIG. 3 is a block diagram for explaining an outline of signal processing in the CATV terminal unit;

FIG. 4 is a schematic block diagram for explaining a signal processing system of a cable modem module unit incorporated into the CATV terminal unit;

FIG. 5 is an exploded, perspective view for explaining a structure of the cable modem module unit;

FIG. 6 is a plan view for explaining an arrangement of respective circuit component parts in the cable modem module unit;

FIG. 7 is a side view, in cross-section, for explaining an arrangement of respective circuit component parts in the cable modem module unit;

FIG. 8 is a side view, in cross-section, for explaining another arrangement of respective circuit component parts in the cable modem module unit;

FIG. 9 is a plan view for explaining another arrangement of respective circuit component parts in the cable modem module unit;

FIG. 10 is a plan view for explaining another arrangement of respective circuit component parts in the cable modem module unit;

FIG. 11 is a perspective view for explaining a structure of a game machine with the cable modem module unit incorporated therein; and

FIG. 12 is a schematic block diagram for explaining an outline of signal processing in the game machine.

### DETAILED DESCRIPTION OF THE INVENTION

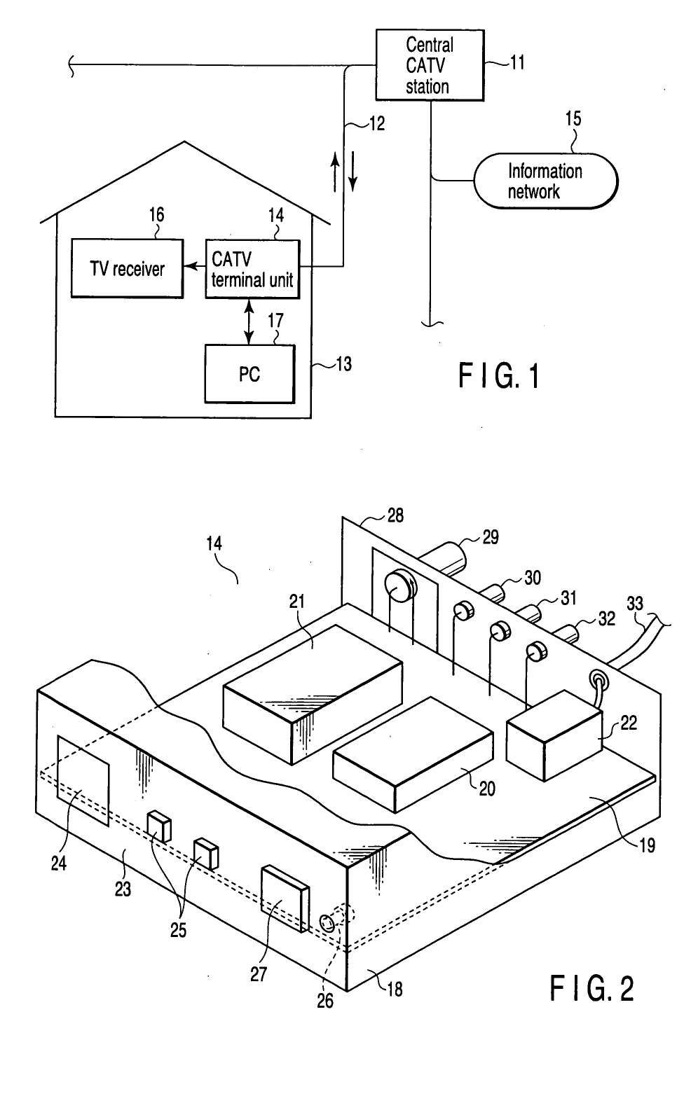

With reference to the drawing, an explanation will be made in more detail below about one embodiment of the present invention. FIG. 1 shows a schematic arrangement of a CATV broadcasting system as explained in connection with the embodiment. In FIG. 1, reference numeral 11 shows a control CATV station.

The central CATV station 11 is connected through a CATV cable 12 to a CATV terminal unit 14 which is installed in each subscriber's home 13. Further, the central CATV station 11 is connected to various kinds of information networks 15 including, for example, the Internet.

The CATV terminal unit 14 has the function of performing channel selection processing on various kinds of programs delivered from the central CATV station 11, demodulation processing on various kinds of information, such as video, audio and character information, from the channel-selected program. The various kinds of such information demodulated at the CATV terminal unit 14 are output to a TV receiver 16 for audio-visual use on the user side.

Further, the CATV terminal unit 14 can be connected to a PC 17. The PC 17 has a cable modem function for allowing data communication to be made with the various kinds of information networks 15 via the central TV station.

From the central CATV station 11 to the CATV terminal unit 14, the various kinds of information, such as the video, audio, character and PC data, are delivered with a “down” signal of a high frequency of, for example, about 90 to 860 MHz. Further, from the CATV terminal unit 14 to the central CATV station 11, information is transmitted with an “up” signal of a high frequency of, for example, about 5 to 65 MHz.

FIG. 2 shows a general structure of the CATV terminal unit 14. The CATV terminal unit 14 has a substantially box-like housing 18 and is so structured as to hold, within the housing 18, a main circuit board 19 where various kinds of circuit parts are formed.

That is, the main circuit board 19 mainly includes a broadcasting signal demodulation section 20 for performing channel selection, demodulation, etc., processing on the various kinds of programs delivered from the central CATV station 11; a cable modem module unit 21 for allowing the PC 17 to conduct data communication with the various kinds of information networks 15 via the central CATV station 11; and a power supply section 22 configured to receive commercial AC (Alternating Current) power and supply necessary power to the broadcasting signal demodulation section 20 and cable modem module unit 21.

On a front panel 23 of the housing 18 are provided a display section 24 for displaying the state of connection to, for example, a receiving channel and central CATV station 11, various kinds of operation elements 25 including a power supply switch; a display unit 26 for showing the ON/OFF state of a power supply; a reception section 27 for receiving operation information from a remote controller, not shown, and so on.

On a back panel 28 of the housing 18 are provided an RF coaxial connector 29 connected to the CATV cable 12; video and audio output terminals 30 and 31 configured to output the video and audio signals which are demodulated by the broadcasting signal demodulation section 20 onto the external TV receiver 16, etc.; a connector 32 configured to allow the connection of the information terminal (for example, the PC 17, etc.) for access to the various kinds of information networks 15 via the central CATV station 11; an AC line 33 for supplying the commercial AC power to the power supply section 22; and so on.

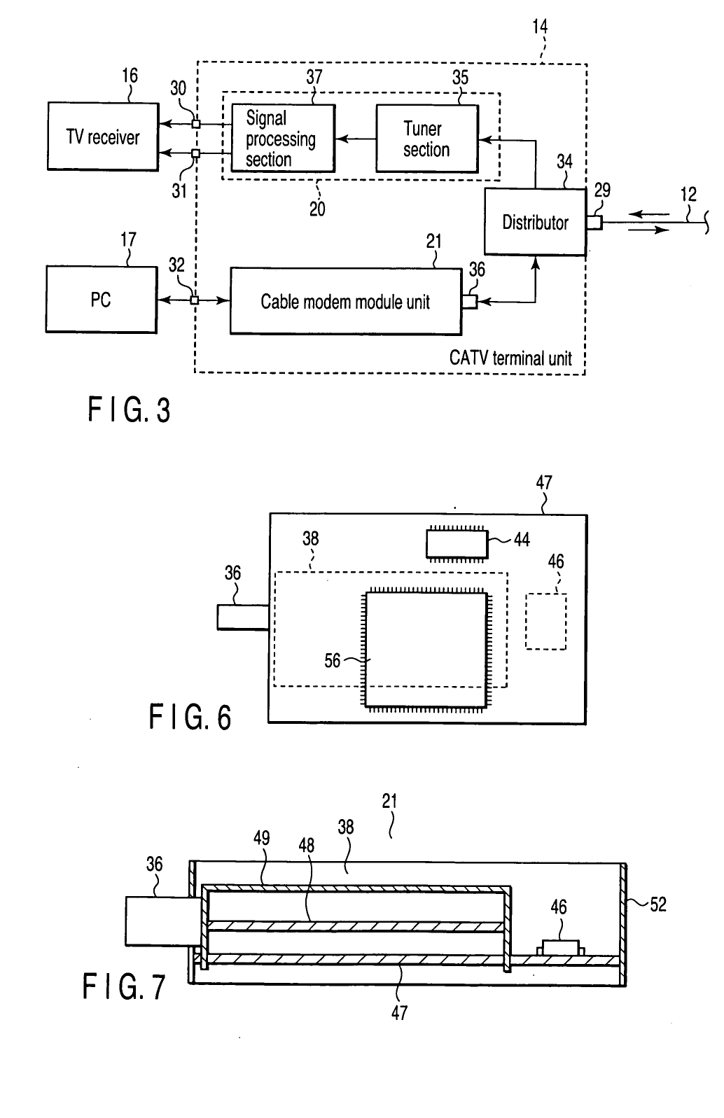

FIG. 3 is a view for explaining an outline of the signal processing in the above-mentioned CATV terminal unit 14. That is, the RF coaxial connector 29 for the above-mentioned CATV cable 12 to be connected is connected to a distributor 34. The distributor 34 has the function of connecting the CATV cable 12 to a tuner section 35 of the above-mentioned broadcasting signal demodulation section 20 and to the RF coaxial connector 36 of the above-mentioned cable modem module unit 21.

By doing so, each program delivered from the central CATV station 11, after being supplied to the tuner section 35 through the CATV cable 12, RF coaxial connector 29 and distributor 34 and being channel-selected, is demodulated into corresponding video and audio signals by a signal processing section 37 in the above-mentioned broadcasting signal demodulation section 20.

The video signal and audio signal demodulated in the broadcasting signal demodulation section 20 are output via corresponding video output terminal 30 and audio output terminal 31 to the external TV receiver 16, etc., for audio-visual use on the user side.

The access information from the PC 17 to the information network 15 is sent to the corresponding information network 15 through the connector 32, cable modem module unit 21, RF coaxial connector 36, distributor 34, RF coaxial connector 29, CATV cable 12 and central CATV station 11.

The response information from the information network 15 is received by the PC 17 through the central CATV station 11, CATV cable 12, RF coaxial connector 29, network 34, RF coaxial connector 36, cable modem module unit 21 and connector 32.

That is, the cable modem module unit 21 has the function of, for example, controlling communication with the central CATV station 11, generating an “up” signal for transmission to the central CATV station 11, demodulating the “down” signal transmitted from the central CATV station 11, and controlling the data communication with an external unit (in this case, the PC 17) connected to the cable modem module unit 21.

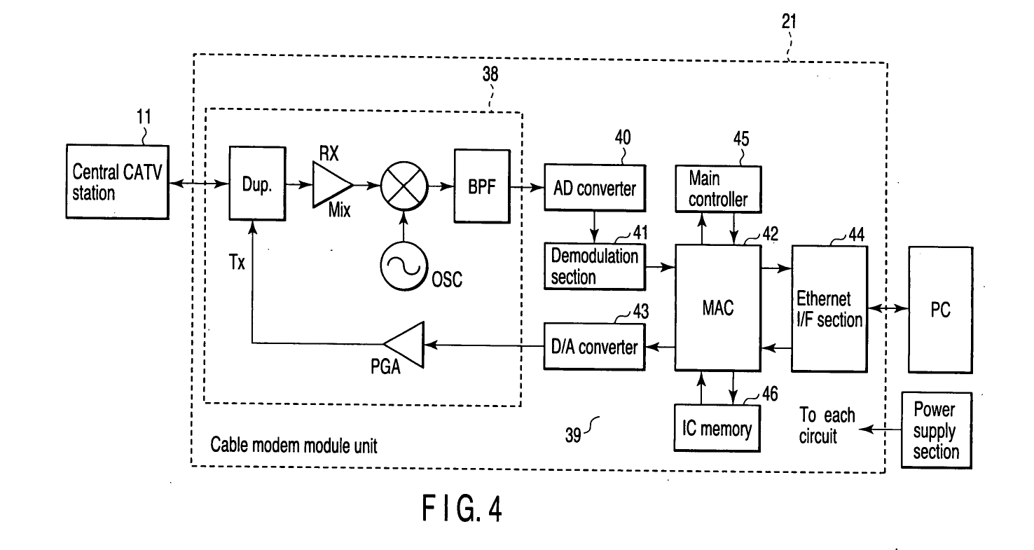

FIG. 4 shows a signal processing section of the cable modem module unit 21. The cable modem module unit 21 includes a tuner section 38 having an analog signal processing unit for handling a high frequency signal which is transmitted and received, through the RF coaxial connector 36, to and from the central CATV station 11 and a digital signal processing section 39 for performing digital processing on a signal to and from the tuner section 38.

The digital signal processing section 39 includes an A/D (Analog/Digital) converter 40 for converting, to a digital signal, an analog “down” signal which is output after being frequency converted in the tuner section 38 and a demodulating section 41 for demodulating a “down” signal as the digital signal into a data form. The “down” signal of a data form is supplied to an MAC (Media Access Control) section 42.

Further, the digital “up” signal which is generated in the MAC section 42 is converted to an analog signal by a D/A (Digital/Analog) converter 43 and transmitted through the tuner section 38 to the central CATV station 11.

Further, the MAC section 42 has the function of communicating with an external unit (in this case, PC 17), connected to the cable modem module unit 21 through the Ethernet interface (I/F) section 44, with the use of the data transmitted to and received from the central CATV station 11.

Further, the digital signal processing section 39 includes a main controller 45, equipped with a built-in microcomputer, etc., for generally controlling the operations of the respective circuit parts including the tuner section 38 and an IC (Integrated Circuit) memory 46. The main controller 45 and IC memory 46 are connected to the MAC section 42.

The power from the above-mentioned power supply section 22 provided outside the cable modem module unit 21 is supplied to the respective circuit parts, including the tuner unit 38 and digital signal processing section 39, in the cable modem module unit 21.

FIG. 5 shows a structure of the cable modem module unit 21. In FIG. 5, reference numeral 47 shows a circuit board. The tuner section 38 and digital signal processing unit 39 shown in FIG. 4 are mounted on the circuit board 47. It is to be noted that, in FIG. 5, the IC memory 46 in the digital signal processing section 39 is seen in a state connected to the circuit board 47.

Of these, the tuner section 38 provides the above-mentioned analog signal processing section with the above-mentioned RF coaxial connector 36 mounted on a tuner circuit board 48. With the RF coaxial connector 36 exposed, the tuner circuit board 48 is held within a shield case 49 which is formed of a material, such as a metal, having an electromagnetic shielding effect.

The tuner section 38 is connected at one terminal to the tuner circuit board 48 and equipped, at the other terminal, with a plurality of analog signal input/output terminals 50 externally extending through the shield case 49. The tuner section 38 is connected to the digital signal processing section 39 on the circuit board 47 by connecting the other end sides of the terminals 50 to the circuit board 47.

The cable modem module unit 21 is configured such that the circuit board 47 with the tuner section 38 and digital signal processing section 39 mounted thereon is surrounded with a substantially tetrahedral shield case 51 or a case similar thereto, the case having the function of shielding external electromagnetic waves.

The shield case 51 comprises a frame-like metal case 52 covering four faces of the circuit board 47, a first cover 53 covering one opening of the tetrahedral metal case 52, and a second cover 54 covering the other opening of the metal case 52.

The metal case 52 has a plurality of terminals 55 for electrical connection between the outside of the cable modem module unit 21 and the digital signal processing section 39 on the circuit board 47 and for power supply from an outside of the cable modem module unit 21 to the various circuits on the circuit board 47.

As the terminals 55a, use is made of those terminals, such as through-connection capacitors, extending through the metal case 52 and solderable directly to another external circuit board (in this case, the main circuit board 19) or those terminals connectable by a connector of a simpler structure. The terminals 55 are connected at one end to the circuit board 47 and at the other end to, for example, the main circuit board 19 in a manner to externally extend through the metal case 52.

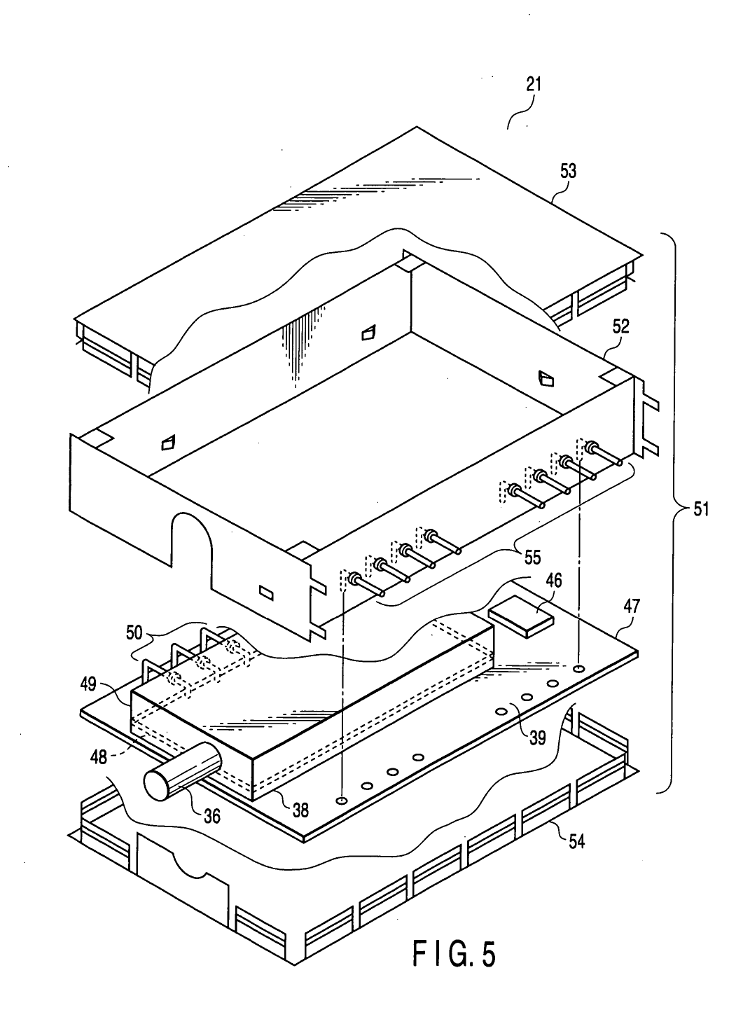

FIG. 6 shows a surface side opposite to a surface on a side where the tuner section 38 of the circuit board 47 is mounted. On this surface side are mounted a semiconductor IC chip 56 including the A/D converter 40, demodulation section 41, MAC section 42, D/A converter 43, main controller 45, and so on, in the digital signal processing section 39, and the Ethernet I/F section 44 in IC chip form.

Here, as shown in FIGS. 5 to 7 from various angles, the IC memory 46 of the digital signal processing section 39 is located on the tuner section 38-mounted surface side on the circuit board 47 in a position opposite to that of the RF coaxial connector 36 with the shield case 49 (constituting a body of the tuner section 38) in between.

In other words, the RF coaxial connector 36, shield case 49 and IC memory 46 are arranged on the circuit board 47 in a substantially straight array in that order, so that the distance between the RF coaxial connector 36 and the IC memory 46 can be made as long as possible.

Generally, signals handled in the tuner section 38 and at the RF coaxial connector 36 are weak analog high-frequency signals and thus involve a risk that any superimposed unwanted signal will lead to a degenerated communication quality.

In the IC memory 46, on the other hand, the inputting/outputting of the digital signal are done at high speeds. The fundamental operation frequency signal component of the digital signal and its high harmonic signal components provide noise with respect to a signal handled at the RF coaxial connector 36, that is, provide an unwanted signal source.

In most cases, the digital signal has a far greater amplitude than signals transmitted through the RF coaxial connector 36. Hence, if the digital signal is unnecessarily applied to the RF coaxial connector 36 and superimposed on a signal being transmitted through the connector 36, the quality of communication will be degraded.

The RF coaxial connector 36 is attached directly to the shield case 49 and, since the RF coaxial cable (in FIG. 3, a cable connected between the distributor 34 and the RF coaxial connector 36) connected to the RF coaxial connector 36 is comprised of a shielded line, a signal passing through the RF coaxial connector 36 is externally shielded by a shielding structure of these.

However, a signal which is sent from the central CATV station 11 into the RF coaxial connector 36 is very weak compared to a signal handled by the IC memory 46 and thus there is a risk that, even under the shielding structure above, the reception quality of the cable modem module unit 21 will be degenerated due to the superimposition by an unwanted signal, or noise, resulting from spurious radiation.

Similarly, when a signal handled by the IC memory 46 is superimposed on the signal sent from the RF coaxial connector 36 due to spurious radiation and flows out into a CATV highway, even if it is weak in amplitude, there is a risk that it will not satisfy the standard performance of the cable modem module unit 21.

In the embodiment above, as shown in FIGS. 5 to 7, the distance between the RF coaxial connector 36 and the IC memory 46 is made as large as possible and, by doing so, the signal amplitude superimposed as noise and unwanted signals generated due to spurious radiation can be suppressed to a minimum, thus reducing adverse affects thereof.

As a result, the quality of the signal which is handled by the RF coaxial connector 36 can be improved and, by doing so, the tuner section 38 can ensure high-quality signal transmission/reception relative to the central CATV station 11. This makes it possible to ensure high-quality communication with a cable modem module unit 21.

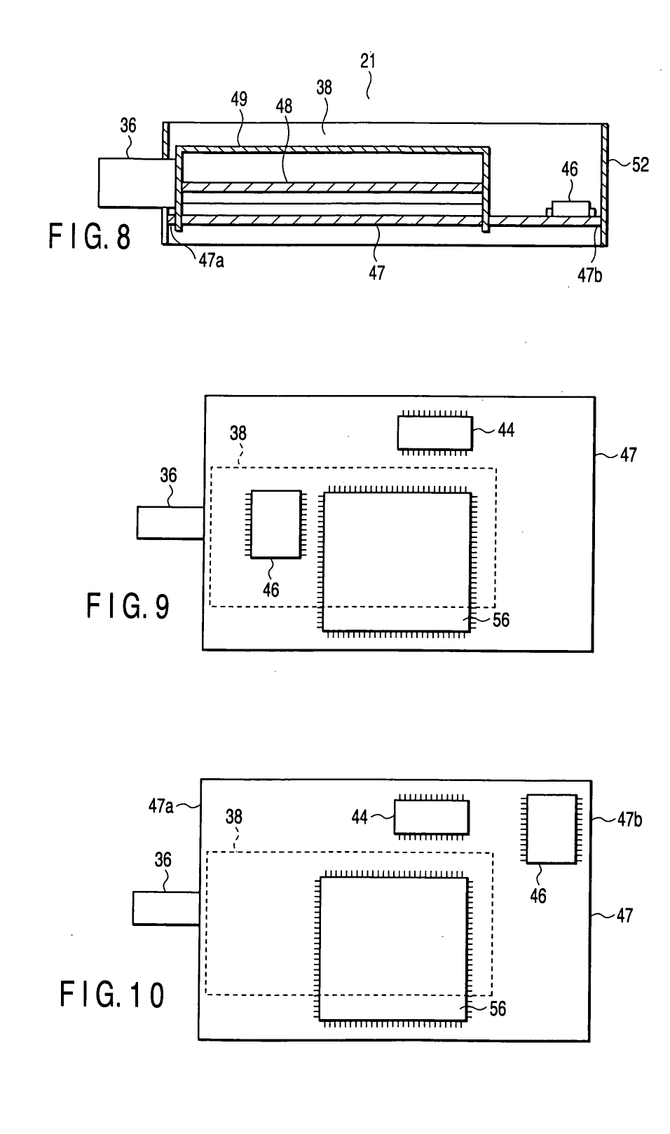

FIGS. 8 to 10 show variations of the above-mentioned embodiment. In FIG. 8, along a plane of circuit board 47, an IC memory 46 is located near an edge portion 47b opposite to the edge portion 47a where an RF coaxial connector 36 extends. According to this arrangement, the RF coaxial connector 36 and IC memory 46 can be effectively spaced an appropriate distance away from each other.

In FIG. 9, an IC memory 46 is located on a circuit board 47 at a surface side opposite to that surface side on which a tuner section 38 is mounted. The circuit board 47 used for the cable modem module unit 21 constitutes a multi-layered (for example, 6-layered) structure where one or more layers (for example, two layers) serve as a ground (GND).

If, therefore, the IC memory 46 is located on the circuit board 47 at a surface side opposite to that surface side on which the tuner section 46 is placed, then, due to the shielding effect by the GND (ground) a digital signal to and from the IC memory 46 can be suppressed from being superimposed on the RF coaxial connector 36 as noise.

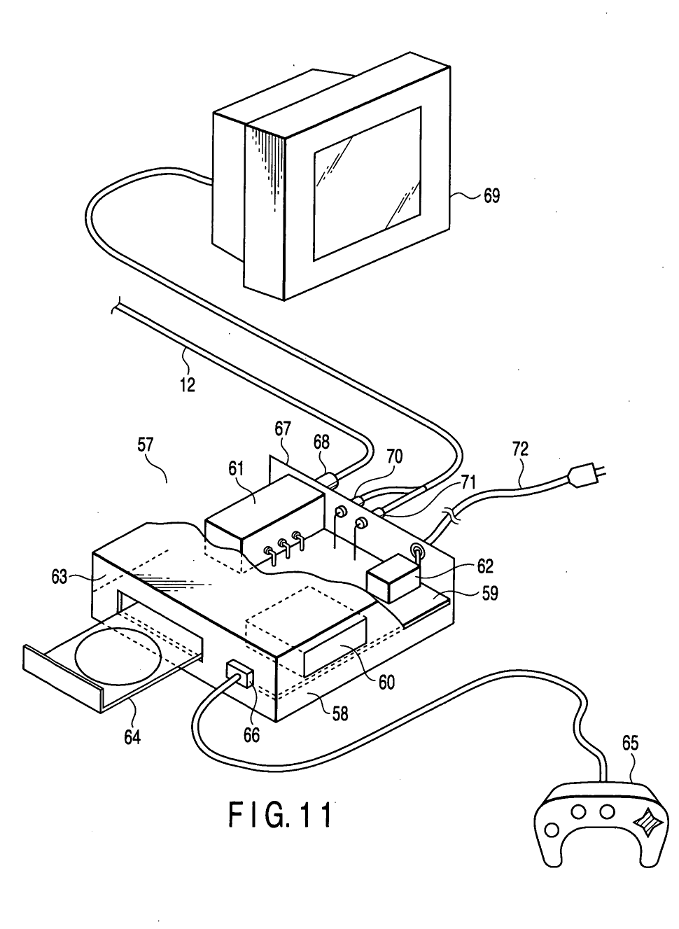

In FIG. 10, on a surface side of a circuit board 47 opposite to that surface side where a tuner section 38 is mounted, an LC memory 46 is mounted along a plane direction and near an edge portion 47b opposite to that edge portion 47a where an RF coaxial connector 36 extends.

According to such an arrangement, a greater distance can be secured between the RF coaxial connector 36 and the IC memory 46 and a more effective structure can be secured due to an additional shielding effect of the GND (ground) layer.

If, as shown in FIG. 10, on the surface side of the circuit board 47 opposite to the surface side where the tuner section 38 is mounted, the LC memory 46 is located near a corner of the circuit board and on an edge portion (a side portion) 47b opposite to the edge portion 47a where the RF coaxial connector 36 extends, then the distance between the RF coaxial connector 36 and the IC memory 46 can be set as large as possible, and a maximal shielding effect can be secured due to the presence of a GND (ground) layer.

Although in the embodiment as set out above the CATV terminal unit 14 has been explained, by way of example, as an electronic unit with the cable modem module unit 21 incorporated therein, for example, a game machine can be used instead.

FIG. 11 shows a general structure of a game machine 57. The game machine 57 has a box-like housing 58 containing a main circuit board 59 with various components thereon.

The main circuit board 59 mainly includes a data processing chip 60, a cable modem module unit 61 having the same structure as the above-mentioned cable modem module unit 21, and a power supply section 62 which accepts commercial AC power to supply necessary power to the data processing chip 60, and cable modem module unit 61.

At a front panel 63 of the housing 58 are arranged a disk playback section 64 for playback which has a disk with game software stored therein, and a connector 66, etc., to which a game controller 65 is connected for operation by the user.

Further, on a back panel 67 of the housing 58 are arranged an RF coaxial connector 68 provided on the cable modem module unit 61; video and audio output terminals 70 and 71 for allowing video and audio signals which are output from the above-mentioned data processing chip 60 to be output to an external TV receiver 69 and so on; and an AC line 72, etc., for supplying commercial AC power to the above-mentioned power supply section 62.

In this game machine 57, unlike the CATV terminal unit 14, the RF coaxial connector 68 of the cable modem module unit 61 is projected from a back panel 67 and connected directly to a CATV cable 12.

Further, the game machine 57 includes an HDD (Hard Disk Drive) capable of storing game software, version-up data or high score data; etc., downloadable from, for example, the central CATV station 11, a communication unit, etc., capable of making/breaking communication with any opponent in a competitive play type game which is entered via the central CATV station 11.

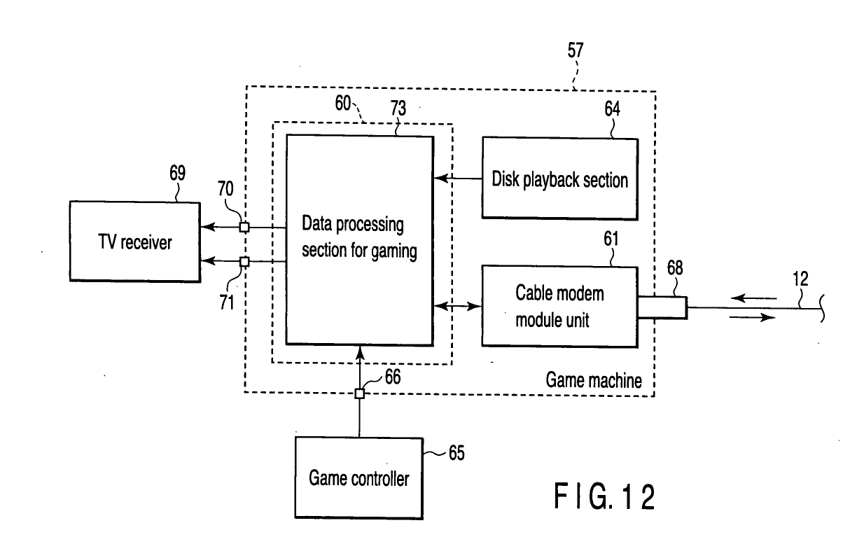

FIG. 12 shows a general arrangement for signal processing in the game machine above. That is, the cable modem module unit 61 and disk playback section 64 are connected to a game data processing section 73 in the game data processing chip 60 set out above. The game controller 65 is connected via the connector 66 to the game data processing section 73. The TV receiver 69 is connected via the video output terminal 70 and audio output terminal 71 to the game data processing section 73.

Further, the game data processing section 73 is driven based on, for example, a game program read by the disk playback section 64, as well as game software, etc., which is stored in the HDD after having been obtained via the cable modem module unit 61 from the central CATV station 11. The game content corresponding to the operation by the game controller 65 is audio-visually displayed on the TV receiver 69.

The game data processing section 73 allows various kinds of game information items which are generated internally to be transmitted via the cable modem module unit 61 to the central CATV station 11 and various kinds of game information items which are transmitted from the central CATV station 11 to be received via the cable modem module unit 61. By doing so it is possible to enjoy a competitive play type game.

Even in the cable modem module unit 61 incorporated in the game machine 57, as set out in connection with FIGS. 5 to 10, the RF coaxial connector 68 and IC memory (not shown) can be arranged as far away from each other as possible, so that the digital signal to and from the IC memory can be suppressed from being superimposed to the RF coaxial connector 68 as noise and unwanted signal resulting from the spurious radiation.

Incidentally, the present invention is not restricted to the above-mentioned embodiment, and various changes and modifications of the constituent elements can be made in a practical stage without departing from the essence of the present invention. Further, various inventions can be embodied by properly combining together a plurality of constituent elements disclosed in the above-mentioned embodiment. For example, some constituent elements may be eliminated from all the constituent elements disclosed in the embodiment and, further, the constituent elements relating to the different embodiments may be properly combined together.

1. A cable modem module unit comprising:
a tuner section configured with an analog signal processing unit for transmitting/receiving a high frequency signal via a coaxial connector;
a first shield case configured to hold the tuner section therein with the coaxial connector externally exposed;
a circuit board having the first shield case thereon and configured to provide a digital signal processing section including a memory for allowing the inputting and outputting of digital data, the digital signal processing section performing digital processing on a signal input to and output from the tuner section; and
a second shield case configured to hold the circuit board and first shield case therein with the coaxial connector externally exposed,
on the same plane of the circuit board, the coaxial connector and memory being located in an opposed relation with the first shield case in between.

2. A cable modem module unit according to claim 1, wherein the coaxial connector, first shield case and memory are arranged in a substantially straight array in that order.

3. A cable modem module unit according to claim 1, wherein the coaxial connector and memory are located near mutually opposite edge portions of the circuit board.

4. A cable modem module unit comprising:
a tuner section configured with an analog signal processing section for transmitting/receiving a high frequency signal via a coaxial connector;
a first shield case configured to hold the tuner section therein with the coaxial connector externally exposed;
a circuit board having the first shield case thereon and configured to provide a digital signal processing section including a memory for allowing the inputting and outputting of digital data, the digital signal processing section performing digital processing on a signal input to and output from the tuner section; and
a second shield case configured to hold the circuit board and first shield case therein with the coaxial connector externally exposed,
the first shield case is mounted on a first surface side of the circuit board and the memory is mounted on a second surface of the circuit board on a surface side opposite to the first surface side.

5. A cable modem module unit according to claim 4, wherein the memory is mounted near an edge portion of the second surface side of the circuit board which is remotest from the coaxial connector.

6. A cable modem module unit according to claim 4 or 5, wherein the circuit board is comprised of a multi-layered structure with most of its layers constituting GND layers.

7. An electronic unit comprising:
a cable modem module unit comprising a tuner section configured with an analog signal processing section for transmitting/receiving a high frequency signal via a coaxial connector, a first shield case configured to hold the tuner section therein with the coaxial connector externally exposed, a circuit board having the first shield case thereon and configured to provide a digital signal processing section including a memory for allowing the inputting and outputting of digital data, the digital signal processing section performing digital processing on a signal input to and output from the tuner section, and a second shield case configured to hold the circuit board and first shield case therein with the coaxial connector externally exposed, on the same plane of the circuit board, the coaxial connector and memory being located in an opposed relation with the first shield case in between; and
a power supply section configured to supply power to the cable modem module unit,
the cable modem module unit is operated with the use of the power supplied from the power supply section.

8. An electronic unit according to claim 7, wherein the coaxial connector, first shield case and memory are arranged in a substantially straight array in that order.

9. An electronic unit according to claim 7, wherein the coaxial connector and memory are located near the opposite edge portions of the circuit board.

10. An electronic unit comprising:
a cable modem module unit comprising a tuner suction configured with an analog signal processing section for transmitting/receiving a high frequency signal via a coaxial connector, a first shield case configured to hole the tuner section therein with the coaxial connector externally exposed, a circuit board having the first shielding case thereon and configured to provide a digital signal processing section including a memory for allowing the inputting and outputting of digital data, the digital signal processing section performing digital processing on a signal input to and output from the tuner section, and a second shield case configured to hold the circuit board and first shield case therein with the coaxial connector externally exposed, the first shield case is mounted on a first surface of the circuit board and the memory is mounted on a second surface on a side opposite to the first surface side; and
a power supply section configured to supply power to the cable modem module unit,
the cable modem module unit is operated with the use of the power supply section.

11. An electronic unit according to claim 10, wherein the memory is mounted near an edge portion of the second surface of the circuit board which is remotest from the coaxial connector.

12. An electronic unit according to claim 10 or 11, wherein the circuit board is comprised of a multi-layered structure with most of its layers constituting GND layers.
